(19) United States
(12) Patent Application Publication
(10) Pub. No.: US 2025/0197656 A1
(43) Pub. Date: Jun. 19, 2025

(54) SYSTEMS TO REDUCE SKINNING OF COATING COMPOSITIONS

(71) Applicant: SWIMC LLC, Cleveland, OH (US)

(72) Inventors: Stacy L. CONTE, Bath, OH (US); Brandon J. GRANT, Avon, OH (US); Olga SOFIANOS, North Royalton, OH (US); Phyliss MANCE, Cleveland, OH (US)

(21) Appl. No.: 18/845,494

(22) PCT Filed: Mar. 10, 2023
(86) PCT No.: PCT/US2023/064084

§ 371 Date: Sep. 10, 2024

Related U.S. Application Data
(60) Provisional application No. 63/479,596, filed on Jan. 12, 2023.
(60) Provisional application No. 63/318,930, filed on Mar. 11, 2022.

(51) Int. Cl. C09D 7/46; C09D 5/02; C09D 7/45; C09D 7/48; C09D 7/63; C09D 7/65; C09D 133/04; C09D 175/04

(52) U.S. Cl. CPC C09D 7/46; C09D 5/022; C09D 5/027; C09D 7/45; C09D 7/48; C09D 7/63; C09D 7/65; C09D 133/04; C09D 175/04

(57) ABSTRACT

Systems and methods for reducing in-container skinning of a coating composition include an optional float disposed on top of an aqueous coating composition in a can and a hydrophobic evaporation suppressing layer disposed on top of the float layer or the coating composition, the hydrophobic evaporation suppressing layer or monolayer being relatively impermeable to water vapor and having a composition that allows it to spread in a thin layer on the float or the coating composition, thereby reducing in-container evaporation.

### REFERENCE TO EARLIER APPLICATIONS

This application claims priority to and the benefit of U.S. Provisional Patent Application No. 63/318,930, filed Mar. 11, 2022, and U.S. Provisional Patent Application No. 63/479,596, filed Jan. 12, 2023, the entirety of which and contents thereof are incorporated by reference in their entirety.

### BACKGROUND

Water-based coating compositions such as paints are often distributed in cans, pails, vats, or other closed containers. During distribution or storage, water may evaporate and condense on the sides or top of the container due to a temperature differential between the container, the coating composition therein, and headspace within the container. This temperature differential can result in skinning—the generation of a polymeric skin on the surface of the wet-state coating composition. During distribution or storage, a skin may grow to as much as ½ cm in depth or more, and may splash or stick to the lid or sides of the distribution container and thereafter become mixed with the fluid coating composition.

Skinning is undesirable for multiple reasons. When a container of coating composition is used, agglomeration from skins can cause spray application equipment to clog or may appear as non-uniform bumps on a surface coated with the coating composition. Typically appearing as either dried coating composition or globules in the coating composition, skins also may be perceived adversely by customers expecting a fully uniform coating composition upon opening the container.

Mechanical solutions for skinning, such as filtering a coating composition after distribution but prior to use, are undesirable due to the increased required effort, time cost, and capital cost, associated with such solutions.

Existing solutions for reducing skinning in the coating composition include addition of a float layer on top of a coating composition, such as water, ethylene glycol, propylene glycol, diethylene glycol or combinations thereof, polyethylene glycol, or glycerin, or a mix of the foregoing with water and surfactant. Although inclusion of a water-only float layer may be adequate in some circumstances, a water-only float is insufficient to prevent in-container skinning for all coating compositions. Alternative solutions, like addition of evaporation suppressants into the coating composition, such as short-chain aliphatics, can impact the evaporation properties and coalescence of the coating composition when applied to a substrate.

More generally, some existing solutions may impart an undesirable level of toxicity to a coating composition or require special processes, unusual personal protective equipment for handling, or are subject to increased regulatory scrutiny. Some chemical additives to prevent skinning also undesirably increase cost. Some existing floats do not consistently spread across the entire surface of the coating composition and thus do not fully prevent skinning. Other solutions can contribute or increase the volatile organic compound (VOC) content of a coating composition or undesirably impact the rheology, tinting, or other characteristics of the coating composition when the float is mixed with the coating composition at the point-of-sale. Inclusion of anti-skinning additives in a coating composition may adversely impact wet-state or dry-state coating characteristics, or may interact or interfere with other components of the coating composition.

A need exists, therefore, for an additive that reduces skinning while maintaining consistent in-container coating composition characteristics.

### SUMMARY OF THE INVENTION

In a first aspect, a system is disclosed herein for reducing in-container skinning of a coating composition comprising an aqueous coating composition that includes a binder and optionally a pigment; and disposed on top of the coating composition, a hydrophobic evaporation suppressing layer.

In a second aspect, a method is disclosed herein for manufacturing an in-container coating composition comprising adding a coating composition to the container; wherein the coating composition includes at least a binder and optionally a pigment; and adding a hydrophobic evaporation suppressing layer disposed on top of the coating composition.

In some approaches, a float layer may be added or present such that the float layer is disposed on top of the coating composition and the hydrophobic evaporation suppressing layer is disposed on top of the float layer.

In some aspects or approaches, the systems or methods of the preceding paragraphs may be combined with one or more optional features, alone or in combination: In some approaches, a float layer may be disposed on top of the aqueous coating composition, and the hydrophobic evaporation suppressing layer disposed on top of the float layer; and/or in some approaches, the hydrophobic evaporation suppressing layer is a monolayer; and/or in some approaches, the evaporation suppressing layer includes one or more polyisobutylene polymers in an amount of 20 to 95 weight percent based on the weight of the composition of the evaporation suppressing layer; one or more silicone polymers in an amount of 0 to 20 weight percent based on the weight of the composition of the evaporation suppressing layer; one or more carriers in an amount of 0 to 20 weight percent based on the weight of the composition of the evaporation suppressing layer; and one or more surfactants in an amount of 0 to 10 weight percent based on the weight of the composition of the evaporation suppressing layer.

In some aspects or approaches, the systems or methods of the preceding paragraphs may be combined with one or more optional features, alone or in combination: wherein the float layer comprises water; wherein the float layer comprises a polyethylene glycol; and/or wherein the float layer includes a humectant; wherein the float layer is present in an amount of at least 1 mL/gallon volume of container, preferably at least 10 mL per gallon volume of container, or even more preferably, at least 20 mL/gallon volume of container, or yet more preferably, at least 40 mL/gallon volume of container; and/or wherein the float layer is present in an amount of at most about 500 mL/gallon volume of container, preferably at most 70 mL per gallon volume of container, or even more preferably, at most 50 mL/gallon volume of container.

In some aspects or approaches, the systems or methods of the preceding paragraphs may be combined with one or more optional features, alone or in combination: wherein the evaporation suppressing layer or monolayer is present in an amount of at least 0.2, more preferably at least 0.5, or even more preferably, at least 0.8 mL per five gallon pail container; and/or wherein the evaporation suppressing layer or monolayer is present in an amount of at most 4.0, more preferably at most 3.0, or even more preferably, at most 2.4 mL per five gallon pail container; and/or wherein the evaporation suppressing layer or monolayer is present in an amount of at least 0.05, more preferably at least 0.15, or even more preferably, at least 0.2 mL per gallon can container; and/or wherein the evaporation suppressing layer or monolayer is present in an amount of at most 1.0, more preferably at most 0.8, or even more preferably, at most 0.6 mL per gallon can container.

In some aspects or approaches, the systems or methods of the preceding paragraphs may be combined with one or more optional features, alone or in combination:
wherein the evaporation suppressing layer or monolayer is present in an amount of at most 2.9 mL per 500 cm² headspace surface area, at most 2.2 per 500 cm² headspace surface area, or at most 1.7 mL per 500 cm² headspace surface area; and/or wherein the evaporation suppressing layer or monolayer is present in an amount of at least 0.1 mL per 500 cm² headspace surface area, at least 0.4 per 500 cm² headspace surface area, or at least 0.6 mL per 500 cm² headspace surface area.

In some aspects or approaches, the systems or methods of the preceding paragraphs may be combined with one or more optional features, alone or in combination: wherein the additive comprises at least one of a pigment, a colorant, a dispersant, a preservative, an UV stabilizer, a wetting agent, an extender, a rheology modifier, or a coalescent; and/or wherein the polysiloxane is a polydimethylsiloxane; and/or wherein the evaporation suppressing layer or monolayer further includes acetic acid; and/or wherein the evaporation suppressing layer or monolayer further comprises a surfactant; and/or wherein the evaporation suppressing layer or monolayer further comprises water; and/or wherein the surfactant of the evaporation suppressing layer or monolayer is an ethoxylated surfactant; and/or wherein the carrier of the evaporation suppressing layer or monolayer is a mineral oil or a vegetable oil; and/or wherein the carrier of the evaporation suppressing layer or monolayer is coconut oil; and/or wherein the PVC of the aqueous coating composition is between about 25 and about 75.

In some aspects or approaches, the systems or methods of the preceding paragraphs may be combined with one or more optional features, alone or in combination: wherein the binder comprises at least one of a (meth) acrylic latex, a vinyl acrylic latex, or a styrene acrylic latex; and/or wherein the polymeric binder comprises a polyurethane; and/or wherein the system has an evaporation loss of no more than 0.5 weight percent, 1.0 weight percent, or 1.5 weight percent when one gallon of such system is stored in a one gallon can with no lid in an environmentally controlled chamber at 120° F. for 5 hours.

The foregoing summary of the invention is not intended to be limiting or to fully disclose all aspects and embodiments of the present invention. Further aspects, including optional aspects, and embodiments of the invention are further described herein.

### DEFINITIONS

The term “binder” as used herein means a film-forming natural or synthetic polymer suitable for use in a coating composition.

The terms “coating composition” refers to a composition that is applied onto a substrate as a protective layer, an aesthetic layer, or both, and may increase the durability or extend the useful life of the resulting product. Paints, stains, clearcoats, and sealants are varieties of coating compositions, but the term coating composition as used herein is not so limited.

The term “paint” means a coating composition including pigment and binder which when applied to form a thin (e.g., 100 μm) wet thickness coating film on a freshly-sanded smooth wood surface, will when dried hide or substantially hide the wood grain and will present a new surface with its own appearance.

The term “stain” means a coating composition including binder which when applied to form a thin (e.g., 100 μm) wet thickness coating film on a freshly-sanded smooth wood surface, will when dried not hide both the wood grain and its texture. When a semi-transparent stain is applied to wood, the wood grain and its texture normally both remain noticeable, whereas when a solid color (viz., opaque) stain is applied the grain normally becomes hidden while the texture normally remains noticeable. A stain typically will soak into a wood or other porous substrate (e.g., concrete) to a much greater extent than will a paint.

The term “pigment” means a natural or synthetic particulate material having light-reflective or light-absorptive characteristics and a surface energy and particle size suitable for use in coloring paints and other coating compositions, and will be construed to include both insoluble materials such as inorganic or organic powdered pigments, and soluble materials such as organic dyes.

The term “on” as in “disposed on” encompasses an arrangement in which the material is directly on top of the subject as well as arrangement in which the material is indirectly on top of the subject, as when one or more intermediate layers are present.

Unless otherwise indicated, the term “polymer” includes both homopolymers and copolymers (i.e., polymers of two or more different monomers).

The term (meth) acrylate polymer includes both methacrylate and acrylate homopolymers and copolymers

The term “pigment volume concentration” or “PVC” when used with respect to a coating composition or a paint means the total percentage of dried coating volume occupied by all pigment or extender species in the coating.

As used herein, the term “monolayer” means a material that when applied to an air/fluid interface will spread to form a continuous thin film on the surface, usually one or several molecules thick.

The term “headspace” when used with respect to a base paint or stain in an openable container refers to an unfilled small portion of the total container volume (for example, about 1 percent to about 33 percent, and in some embodiments about 1 percent to about 15 percent of the total container volume).

The terms “comprises” and variations thereof do not have a limiting meaning where these terms appear in the description and claims Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein, “a” “an,” “the” “at least one,” and “one or more” are used interchangeably. Thus, for example, a composition that comprises ‘a’ component can be interpreted to mean that the composition includes ‘one or more’ of that class of component. As used herein, the term ‘or’ is generally employed in its usual sense including “and/or” unless the content clearly dictates otherwise. The term “and/or” means one or all of the listed elements or a combination of any two or more of the listed elements.

Also herein, the recitations of numerical ranges by end points include all numbers Subsumed within that range as well as the endpoints (e.g., 1 to 5 includes 1, 1.5, 2, 2.75, 3, 3.80, 4, 5, etc.). Herein, the statement “up to” a number (e.g., “up to” 50) includes that number (e.g., 50).

Numerical limits are approximate and may vary based on the amount of usual error in measurement typical in the art for measurement of the identified component.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Disclosed herein is a system and method for reducing in-can skinning of a coating composition comprising an aqueous coating composition that includes at least a binder and optionally a pigment; and a hydrophobic evaporation suppressing layer disposed on top of the coating composition. In some approaches, a float layer may be disposed on the coating composition and the hydrophobic evaporation suppressing layer disposed on the float layer.

Surprisingly, it has been found the evaporation suppressing layer as described herein contains components that are relatively impermeable to water vapor, and spreads in a thin layer across the surface of the coating composition or the float layer, thereby reducing or thwarting the evaporation/condensation cycle that results in in-can skinning during product distribution or storage of a coating composition. In contrast to previous evaporation suppressing additives used with coating compositions, the present invention is not added or mixed with the bulk of a coating composition in a larger quantities in order to affect evaporation properties like vapor pressure. Rather, the evaporation suppressing layer described herein prevents evaporation by spreading across the surface of the coating composition in a thin layer at very low amounts and is relatively impermeable to transmission of water vapor. Consequently, the evaporation suppressing layer of described herein can reduce in-can evaporation and thus reduce skinning even though it is used in very small amounts, in the range of milliliters/gallon of coating composition. Despite the small amount used, the evaporation suppressing layer surprisingly reduces evaporation of water from the coating composition.

In contrast to previous solutions to reduce skinning in which organic components were added to a coating composition to reduce its vapor pressure, the present invention does not significantly increase the amount of volatile organic compounds (VOCs) in the coating composition, which are undesirable in some applications.

Paints generally are manufactured in a base color and distributed in containers such as a metal can or plastic pail to the point of sale. At the point of sale, the container is opened and tinted by adding one or more colorants, after which the coating composition is shaken or mixed thoroughly to distribute the colorant. Although evaporation suppressing layers of the present invention spread evenly across the surface of a coating composition, due to its high hydrophobicity, the evaporation suppressing layer would be expected to be immiscible in the water carrier of an aqueous coating composition, and would thus undesirably separate from the coating composition after usual shaking or mixing at the point of sale, or otherwise degrade desirable characteristics of the coating composition, like adhesion to a surface or recoatability (the ability to apply one layer of coating on another layer of coating). Indeed, evaporation suppressing compositions containing polyisobutylene such as the compositions described herein conventionally have been used in applications where the composition is deposited on an aqueous material and remains there permanently or near-permanently such as large water storage reservoirs (e.g., dammed lakes) in hot, dry climates. Surprisingly, however, it has been found that the hydrophobic evaporation suppressing layer as disclosed herein can be mixed with (or shaken into) an aqueous coating composition at the point of sale and not unacceptably impact coating composition properties like adhesion and application quality, which depend on the ability of the coating composition to mix with itself as well as recoatability. Thus, the present invention allows for the reduction or elimination of in-can skinning of an aqueous coating composition.

The aqueous coating composition to be protected from skinning includes at least a polymeric binder and optionally a pigment in a water-based carrier. An aqueous coating composition protected in the disclosed systems and methods normally will contain one or more polymeric binders and optionally one or more pigments. In some approaches, the polymeric binder may be a latex polymer or water-dispersible binder. Such water-dispersible binders may be water-dispersible following the addition of a suitable neutralizing agent such as ammonia or an amine.

The polymeric binder may include, for example, a polymeric binder used in a paint formulation, a clear-coat formulation, a stain formulation, a sealant formulation, or the like, and may be used in a water-based formulation or a solvent-free formulation. The polymeric binder may be present in a carrier liquid in some examples and may be dispersed in the carrier liquid (e.g., in an emulsion stabilized colloidally or using a surfactant), present as a solute in the carrier liquid (e.g., in a solution polymer), or the like.

In some examples, the polymer binder may be based on polyurethane chemistry, latex chemistry, (meth) acrylate chemistry, acetate chemistry (e.g., ethylene-vinyl acetate), or the like. The polymer binder may be synthetic or may be a naturally occurring polymer, biological polymer, or a bio-based polymer, such as a polysaccharide, a polypeptide, a lipid, a nucleic acid-based polymer, either crosslinked or uncrosslinked. Some example polymer binders include poly (ethylene-vinyl acetate) “PEVA,” a vinyl ester homopolymer or copolymer, a silane or fluorine containing latex emulsion, or the like. For example, the polymeric binder may include a latex-based paint formulation and may include a polymeric binder including a latex polymer that is surfactant or colloidally stabilized in the latex emulsion.

The latex polymer may include a (meth) acrylic latex, a vinyl acrylic latex, or a styrene acrylic latex. The latex polymer may be formed from reactants including methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy) ethyl methacrylate (AAEM), diacetone acrylamide (DAAM), acrylamide, methacrylamide, methylol (meth) acrylamide, styrene, α-methyl styrene, vinyl toluene, vinyl acetate, vinyl propionate, allyl methacrylate, and mixtures thereof. Some preferred monomers include styrene, methyl methacrylate, methacrylic acid, acetoacetoxy ethyl methacrylate, butyl acrylate, butyl methacrylate, and the like.

The binder may also include other optional monomers polymerized into the polymer as needed for a particular application. For instance, the polymer may further include ureido monomers, amino monomers, sulfonate monomers or surfactants, silane monomers, phosphate monomers or surfactants, carboxyl monomers or surfactants, and combinations thereof. In some approaches, the copolymer may further include vinyl monomers such as allyl imidazolidinone, allyl acetoacetates, allyl epoxies, epoxy acrylates, carbonyl monomers, other sulfonates, other phosphonates, vinyl phosphonate, allyl hydroxypopyl sodium sulfonate, allyloxy hydroxypropyl sodium sulfonate, and combinations thereof as needed for a particular application.

Coating compositions that are paints typically will include one or more pigments. Suitable pigments present in the coating composition of the present disclosure may be titanium dioxide (TiO₂), zinc oxide (ZnO₂), calcium carbonate (CaCO₃), talc, clay materials, aluminum oxide, silicon dioxide, magnesium oxide, zinc sulfate, combinations thereof, or other known pigment or inorganic particles suitable for paints and other coatings. In some approaches, the pigment or inorganic particle is titanium dioxide, which may comprise anatase titanium dioxide or rutile titanium dioxide, or a mixture of the two. In other approaches, the pigment or inorganic particle comprises rutile titanium dioxide, to the exclusion of anatase titanium dioxide. In some approaches, the rutile titanium dioxide is surface treated with an inorganic oxide, such as silica (SiO₂). An opacifying pigment may be provided in powder form or in an aqueous slurry. An example of a titanium dioxide that is suitable for use is Ti-Pure® R-706, which is commercially available from Du Pont de Nemours Inc.

In addition to the binder and pigment, coating compositions of the present invention may also include one or more dispersants, preservatives, UV stabilizers, wetting agents, extenders, rheology modifiers, and/or coalescents as understood by persons having ordinary skill in the art.

Coating compositions of the present disclosure are typically distributed and sold in a container such as an openable, coated, or uncoated metal can or a plastic pail, but any suitable container may be used. Cans typically have a size of one gallon but may be larger or smaller and are capped with a metal lid. Pails are typically plastic with a plastic lid, five gallons in size but similarly may be larger or smaller. After manufacturing of the coating composition, the coating composition is added to the can or pail in a filling line. The volume of the openable container that is not filled with liquid coating composition is the headspace of the container. In a cylindrical container, the headspace will have a surface area that is the sum of the surface area of the coating composition, a surface area of the lid, and an annular surface area of the container sides.

In some approaches, a float layer may be disposed on the top of the coating composition and the hydrophobic evaporation suppressing layer disposed on top of the float layer. The float may be added on top of the in-container coating composition by any suitable means such as addition through a spray or flow nozzle.

In some approaches, the float layer may be water, ethylene glycol, propylene glycol, diethylene glycol, polyethylene glycol, glycerin, or mixtures thereof. Water is a preferred float. In some approaches, the float layer may comprise a polyethylene glycol. In some embodiments, the float may include polyethylene glycol mixed with water, or a polyethylene glycol float disposed on top of a water float. Thus, the float may comprise one or more humectants. The float may also include one or more phosphate ester surfactants.

The float may be disposed on the top of a coating composition by any suitable method such as pouring, squiring through a nozzle, spraying, or aerosol deposition. The amount of float added depends on the coating composition and is preferably at least 1 mL per gallon volume of container, at least 10 mL per gallon volume of container, or at least 20 mL per gallon volume of container, or even more preferably, at least 40 mL/gallon volume of container. The amount of float is preferably at most 500 mL per gallon volume of container, at most about 70 mL per gallon volume of container, or at most about 50 mL per gallon volume of container.

A float layer preferably may further include a biocide. Some suitable biocides or fungicides include those sold under the trade names ROZONE™ 2000, BUSAN™ 1292 and BUSAN™ 1440 from Buckman Laboratories, Memphis, Tennessee; POLYPHASE™ 663 and POLYPHASE™ 678 from Troy Chemical Corp., Florham Park, New Jersey; and KATHON™ LX from Rohm and Haas Co. A biocide or fungicide may be added to the float separately or separately mixed with water then added to the float.

According to the invention, an evaporation suppressing layer is disposed on the float if present, or otherwise on the coating composition. The evaporation suppressing layer may be added by any suitable method, such as pouring, via dropper, via syringe, spraying, or aerosol deposition. Following addition of the coating composition, optional float layer, and evaporation suppressing layer, the container is sealed for distribution, storage, and sale.

In some embodiments, the evaporation suppressing layer is disposed on the float or the coating composition in an amount of at least 0.2, more preferably at least 0.5, or even more preferably, at least 0.8 mL per five gallon pail container. The evaporation suppressing layer is disposed on the float or the coating composition in an amount of at most 4.0, more preferably at most 3.0, or even more preferably, at most 2.4 mL per five gallon pail container.

In some embodiments, the evaporation suppressing layer is disposed on the float or the coating composition in an amount of at least 0.05, more preferably at least 0.15, or even more preferably, at least 0.2 mL per gallon can container. The evaporation suppressing layer is disposed on the float or the coating composition in an amount of at most 1.0, more preferably at most 0.8, or even more preferably, at most 0.6 mL per gallon can container.

In some embodiments, the evaporation suppressing layer is disposed on the float or the coating composition in an amount of at most 2.9 ml, per 500 cm² headspace surface area, at most 2.2 per 500 cm² headspace surface area, or at most 1.7 mL per 500 cm2 headspace surface area. The evaporation suppressing layer is disposed on the float or the coating composition in an amount of at least 0.1 mL per 500 cm² headspace surface area, at least 0.4 per 500 cm² headspace surface area, or at least 0.6 mL per 500 cm² headspace surface area.

The hydrophobic evaporation suppressing layer described herein includes at least a polyisobutylene polymer. Polyisobutylene is known to be relatively impermeable to gas transmission (such as water vapor), and is also highly hydrophobic. The polyisobutylene polymer is present in the hydrophobic evaporation suppressing layer in an amount of 20 to 95 weight percent based on the weight of the composition of the evaporation suppressing layer. Preferably, the polyisobutylene polymer is present in an amount of at least 30, at least 40, at least 50, at least 60, or at least 80 weight percent based on the weight of the composition of the evaporation suppressing layer. Preferably, the polyisobutylene polymer is present in an amount of at most 80, at most 70, at most 60, at most 50, or at most 30 weight percent based on the weight of the composition of the evaporation suppressing layer. A polyisobutylene (also called isobutene) polymer of the present invention may be a homopolymer of isobutylene or a copolymer, or alternatively may be butyl rubber, a copolymer of isobutylene with isoprene. Additives like a silicone polymer or a surfactant are added to allow the polyisobutylene to spread across a liquid surface such as the float layer or the coating composition.

The hydrophobic evaporation suppressing layer described herein further may include one or more silicone polymers in an amount of 0 to 20 weight percent based on the weight of the composition of the evaporation suppressing layer. Preferably, the silicone polymer is present in an amount of at least 1, at least 2, at least 5, at least 10, or at least 15 weight percent based on the weight of the composition of the evaporation suppressing layer. Preferably, the silicone polymer is present in an amount of at most 18, at most 15, at most 12, at most 10, at most 7, at most 5, or at most 3 weight percent based on the weight of the composition of the evaporation suppressing layer. Preferably the silicone polymer is a polydimethyl siloxane. The silicone polymer may be Dow Corning “200 Fluid”. Although the silicone polymer is typically permeable to gasses, its inclusion promotes spreading of the polyisobutylene across the entire surface of the liquid float layer. Thus, the hydrophobic evaporation suppressing layer is relatively impermeable to water vapor and spreads across the entire surface of the float layer or coating composition that would otherwise be available for evaporation.

The hydrophobic evaporation suppressing layer further may include one or more carriers in an amount of 0 to 20 weight percent based on the weight of the composition of the evaporation suppressing layer. The carrier may be any liquid capable of dissolving, emulsifying, or dispersing the components of the evaporation suppressing layer, or being dissolved or dispersed in the components of the evaporation suppressing layer. The carrier may be a solvent, an oil, a polymer, or a lipid. Preferably the carrier is a mineral oil or a vegetable oil, and even more preferably, coconut oil. Preferably, the carrier is present in an amount of at least 1, at least 2, at least 5, at least 10, or at least 15 weight percent based on the weight of the composition of the evaporation suppressing layer. Preferably, the carrier is present in an amount of at most 18, at most 15, at most 12, at most 10, at most 7, at most 5, or at most 3 weight percent based on the weight of the composition of the evaporation suppressing layer.

In some approaches, the evaporation suppressing layer further may include one or more surfactants in an amount of 0 to about 10 weight percent based on the weight of the composition of the evaporation suppressing layer. Any suitable surfactant that is miscible with the evaporation suppressing layer may be used. The surfactant may be a polyalkylene oxide of a synthetic alcohol, tetramethyl decynediol, polyalkylene glycol or a polyalkylene ester, or a polyalkoxyester. The surfactant also may be an ethoxylated surfactant such as nonylphenol ethoxylate, or octylphenol ethoxylate. The evaporation suppressing layer preferably is free of alkyl phenol ethoxylate surfactants. Preferably the surfactant is present in an amount of at least 0.5 weight percent based on the weight of the composition of the evaporation suppressing layer. Preferably the surfactant is present in an amount of at most 5 weight percent based on the weight of the composition of the evaporation suppressing layer.

In some approaches, the evaporation suppressing layer may also include acetic acid as a stabilizer in an amount of 0 to 5 weight percent based on the weight of the composition of the evaporation suppressing layer. Preferably, the stabilizer is present in an amount of at least 0.5 weight percent based on the weight of the composition of the evaporation suppressing layer. Preferably, the stabilizer is present in an amount of at most 3 weight percent based on the weight of the evaporation suppressing layer.

The components of the evaporation suppressing layer are blended or mixed by any suitable means prior to disposition on the surface of the coating composition or float layer.

In some approaches, the hydrophobic evaporation suppressing layer may be a monolayer. A monolayer is a material that when applied to an air/liquid interface, spreads across the surface to form a thin film.

The evaporation suppressing layer of the present invention may be, for instance, Waterguard®, available from Aquatic Technologies, Victoria, Australia, which is marketed as useful in large bodies of water like lakes and streams in circumstances in which the compound is expected never to be mixed with the underlying body of water. The evaporation suppressing layer may be one or more compositions described in International Publication Number WO 2014/203101 A1, filed on May 29, 2014.

Surprisingly, it has been found that a highly hydrophobic compound like polyisobutylene can be employed in an evaporation suppressing layer, and that it will properly mix with an aqueous coating composition at the point-of-sale and not adversely coating composition properties like adhesion to substrate.

### EXAMPLES

### Experiment 1: Comparison of Evaporation Loss With and Without Evaporation Suppressing Hydrophobic Layer in Simulated Environment

The rate of water evaporation from a conventional, zero VOC acrylic latex interior paint was tested comparing (1) a sample of a conventional acrylic latex paint alone (Sample A); (2) a sample with 8 g water float/200 g paint (Sample B); and (3) Sample C with 0.19 g of Waterguard®¹ hydrophobic evaporation suppressing layer disposed on the top surface of sample B. After preparation and sealing in a glass jar, samples were transported between floors to mimic shaking that occurs during distribution. The jar lids were then removed and the samples were placed in an environmentally controlled hot room at 41.6° C. and 24% relative humidity for approximately 4 hours. Each sample was then weighed and the percent evaporation calculated.

TABLE 1
Effect of Evaporation Suppressing Layer on Evaporation Loss With and Without

| | | | | Total | | | |
|---|---|---|---|---|---|---|---|
| | | | Evaporation | Weight | | | |
| | Amount | | Suppressing | Added | Liquid mass | Mass | |
| Sample | of Paint | Water | Layer (g) | to Jar | after hot | evaporated | Percent |
| Description | (g) | Float (g) | (calculated) | (g) | room | (g) | Change |
| Sample A | 199.98 | 0 | 0 | 199.98 | 197.95 | 2.03 | 1.00% |
| Sample B | 199.99 | 8 | 0 | 207.99 | 204.46 | 3.53 | 1.70% |
| Sample C | 199.99 | 8 | 0.19 | 208.18 | 207.19 | 0.99 | 0.50% |

The results show that use of the Waterguard® evaporation suppressing layer disposed on a water float decreases water evaporation substantially compared to use of water float alone (70% evaporation reduction) or no float (50% evaporation reduction).

### Experiment 2: Comparison of Evaporation Loss With and Without Evaporation Suppressing Hydrophobic Layer in Paint Samples

The test of Example 1 was performed in duplicate on samples in which a water or polyethylene glycol (PEG) float layer was employed to assess the effectiveness of two amounts of Waterguard® used as an evaporation suppressing compound added to one gallon container of a conventional acrylic latex paint, except that the test conditions of the environmentally controlled hot room were 48.9° C. (120° F.) and 18% relative humidity. After approximately four hours of conditioning in the hot room, the samples were weighed to assess the amount of weight lost by evaporation. The results are as follows:

TABLE 2
Effect of Evaporation Suppressing Layer on Evaporation Loss
With and Without Water or Polyethylene Glycol Float

| | | | | | Average |
|---|---|---|---|---|---|
| | | | | Amount | Percent |
| | | | | Evapo- | Weight |
| | | | | ration | Decrease |
| | | | | Sup- | Based on |
| | | | | pressing | Weight of |
| | | | Amount | Com- | Coating |
| Sam- | | Float | Float | pound | Com- |
| ple | Sample Description | Type | (mL) | (mL) | position |
| D | Coating Composition | None | 0 | 0 | 1.35% |
| E | Coating Composition + | Water | 41.2 | 0 | 3.20% |
| | Water Float | | | | |
| F | Coating Composition + | Water | 41.2 | 0.1 | 2.05% |
| | Water Float + 0.1 mL | | | | |
| | Compound | | | | |
| G | Coating Composition + | Water | 41.2 | 1.0 | 0.25% |
| | Water Float + 1.0 mL | | | | |
| | Compound | | | | |
| H | Coating Composition + | Polethylene | 41.2 | 0 | 3.20% |
| | PEG Float | Glycol | | | |
| I | Coating Composition + | Polethylene | 41.2 | 0.1 | 2.20% |
| | PEG Float + 0.1 mL | Glycol | | | |
| | Compound | | | | |
| J | Coating Composition + | Polcthylenc | 41.2 | 1.0 | 0.20% |
| | PEG Float + 1.0 mL | Glycol | | | |
| | Compound | | | | |

The results demonstrate that utilization of 1.0 mL evaporation suppressing compound reduces evaporation with either a water or polyethylene glycol float. ¹ Available from Aquatic Technologies, Victoria, Australia.

### Experiment 3: Effect of Varying Amounts of Hydrophibic Evaporation Suppressing Layer on Evaporation Loss

29.5 mL water/gallon paint was added as a float on top of a conventional zero VOC interior acrylic latex paint in a five gallon pail. Watergard® compound was added on top of the water float in the amounts indicated. Duplicate samples were prepared and placed without lids in an environmentally controlled hot room at 120° F. and 29% relative humidity for approximately 5 hours and the evaporated weight was assessed.

TABLE 3
Evaporation Amount With Varied Amounts of Evaporation
Suppressing Layer.

| | Amount Evaporation | Percent |
|---|---|---|
| | Suppressing Compound | Weight |
| Sample | (mL/gallon) | Change |
| K | 0 | 1.3% |
| L | 0.4 | 0.8% |
| M | 0.8 | 0.3% |
| N | 1.6 | 0.3% |

The results indicate that suppression of evaporation occurs at 0.4 mL/gallon of the evaporation suppressing compound, and that equivalent evaporation suppression occurs at addition levels of 0.8 and 1.6 mL/gallon compound.

### Prophetic Experiment 4

Based on the results of example 3, it is expected that the evaporation suppression activity of the evaporation suppressing compound will increase linearly with the amount of surface area of the coating composition, container lid, and the surface area of container walls in the fill gap between the surface of the coating composition and the lid (the container walls in the headspace).

### Experiment 5: Comparative Evaluation of Hydrophobic Evaporation Suppressing Layer on Paint Properties

A series of tests were performed to assess whether the performance characteristics of a paint would be adversely impacted when the paint was mixed with a hydrophobic evaporation suppressing material. When used to prevent skinning during shipment and distribution, a hydrophobic evaporation suppressing layer would be mixed with the paint on which the layer is deposited (usually by shaking) at the point of sale.

Paint samples² were prepared with a water or polyethylene glycol float layer. Comparative tests were performed on the samples with or without an additional layer consisting of Waterguard® hydrophobic evaporation suppressing material. If present, the water of polyethylene glycol float was present in an amount of 45 mL/gallon. If present, the hydrophobic evaporation suppressing layer was deposited on top of the float in an amount of 0.4 mL/gallon. Each sample was shaken for 6 minutes prior to the test.

TABLE 4
Samples Tested in Experiment 5

| | | Evaporation Suppressing |
|---|---|---|
| Sample | Float | Monolayer Present |
| O | Water | Yes |
| P (control) | Water | No |
| Q | Polyethylene Glycol | Yes |
| R (control) | Polyethylene Glycol | No |

Each sample was mixed thoroughly by shaking for 6 minutes, and were then assessed by standard methods for washability, blocking, scrub resistance, general appearance, recoatability, adhesion to surface with primer, gloss and sheen, and application quality. ² Pro Mar 200, Eg-Shel sheen, extra white, product B20W12651, available from The Sherwin-Williams Company, Cleveland, Ohio.

### Washability

Washability was assessed by the method of ASTM D4828-94. All measurements were taken after 100 cycles of mechanical washing, with the exception of stain by crayon, which was fully removed following 17 or 18 cycles. The liquid cleanser employed was Formula 409 All Purpose Cleaner, available from The Clorox Company, Oakland, California. Results are shown in Table 5.

TABLE 5
Washability Test Results3

| | Wash Evaluation (Wet) | | | | Gloss Change (Dry) | | | | Color Change (Dry) | | | | Erosion | | | |
|---|---|---|---|---|---|---|---|---|---|---|---|---|---|---|---|---|
| Stain | O | P⁴ | Q | R⁵ | O | P | Q | R | O | P | Q | R | O | P | Q | R |
| Coffee | 3 | 3 | 3 | 3 | N | N | N | N | SD | SD | SD | SD | N | N | N | N |
| Tea | 5 | 5 | 5 | 5 | N | N | N | N | SL | SL | SL | SL | N | N | N | N |
| Wine | 3 | 3 | 3 | 3 | N | N | N | N | N | N | N | N | N | N | N | N |
| Grape Juice | 3 | 3 | 3 | 3 | N | N | N | N | SL | SL | SL | SL | N | N | N | N |
| Ketchup | 0 | 0 | 0 | 0 | N | N | N | N | N | N | N | N | N | N | N | N |
| Mustard | 3 | 3 | 3 | 3 | N | N | N | N | N | N | N | N | N | N | N | N |
| Marker | 10 | 10 | 10 | 10 | N | N | N | N | * | * | * | * | N | N | N | N |
| Pen | 3 | 3 | 3 | 3 | N | N | N | N | SL | SL | SL | SL | N | N | N | N |
| Pencil | 5 | 5 | 5 | 5 | N | N | N | N | CL | CL | CL | CL | N | N | N | N |
| Crayon | 10 | 10 | 10 | 10 | N | N | N | N | * | * | * | * | N | N | N | N |
| Lip Stick | 6 | 6 | 6 | 6 | N | N | N | N | CL | CL | CL | CL | N | N | N | N |
| Mineral-oil | 6 | 6 | 6 | 6 | N | N | N | N | CL | CL | CL | CL | N | NN | | N |
| based soilant | | | | | | | | | | | | | | | | |

The test indicates that inclusion of the hydrophobic evaporation suppressing layer and subsequent mixing with the coating composition does not adversely impact ³ Washability test performed per ASTM D4828-94, titled “Standard Test Methods for Practical Washability or Organic Coatings.” Formula 409 cleanser used as liquid cleanser. Washability assessed after 100 mechanical cycles for all stains except crayon, which was fully removed after 17 or 18 cycles. Mineral oil-based soilant is that described in ASTMD3450. * indicates stain washed away.4, 4 Samples P and Q are controls, as indicated in Table 4. washability of the coating composition. The data shows identical, or nearly identical washability performance with and without inclusion of the hydrophobic evaporation suppressing layer.

### Blocking

Blocking is the undesirable sticking together of two painted surfaces when pressed together or placed in contact with one another for an extended period of time. Blocking resistance was assessed by ASTMD4946-89 (2017), and graded according to the scale shown in D4946, in which a numerical rating of 10 indicates no tack (perfect performance) and a numerical rating of 0 indicates 75-100% seal (very poor performance). The results is shown in Table 6.

TABLE 6
Blocking Resistance Test Results

| | 1 Day | | | | 3 Day | | | | 7 Day | | | |
|---|---|---|---|---|---|---|---|---|---|---|---|---|
| Sample ID | Rep 1 | Rep 2 | Rep 3 | Ave | Rep 1 | Rep 2 | Rep 3 | Ave | Rep 1 | Rep 2 | Rep 3 | Ave |
| O | 0 | 0 | 0 | 0 | 0 | 0 | 0 | 0 | 0 | 0 | 0 | 0 |
| P | 0 | 0 | 0 | 0 | 0 | 0 | 0 | 0 | 0 | 2 | 0 | 0.67 |
| Q | 0 | 0 | 0 | 0 | 0 | 0 | 0 | 0 | 0 | 0 | 0 | 0 |
| R | 0 | 0 | 0 | 0 | 0 | 0 | 0 | 0 | 0 | 0 | 2 | 0.67 |

The data shows nearly identical blocking resistance of the control paints as compared to paints mixed with the hydrophobic evaporation suppressing material.

### Scrub Resistance

Scrub resistance is the resistance of a paint to erosion caused by scrubbing. Scrub resistance was measured according to ASTM D2486-17, titled “Standard Test Methods for Scrub Resistance of Wall Paints.” Results are shown in Table 7.

TABLE 7
Scrub Resistance Test Results⁶

| Sample | 1^{st} Break | Full Break |
|---|---|---|
| O | 713 | 1118 |
| P | 756.5 | 1155.5 |
| Q | 769.5 | 1195.5 |
| R | 831.5 | 1201 |

### General Appearance of Evaporation Suppressing Layer in Wet Paint Simulated in Storage

Duplicate paint samples with the hydrophobic evaporation suppressing material were shaken and assessed for syneresis, agglomeration, foaming, separation of layers, ⁶ Test performed per D2486-17, Method A. Mean value of two drawdown tests reported. color separation, and partial separation of layers at 3 days, 7 days, and 14 days following shaking. No significant defects were found in any of Samples O, P, Q, or R.

TABLE 8
General Appearance Results.

| | | 3-Day | 7-Day | |
|---|---|---|---|---|
| Sample | Rep | Observation | Observation | 14-Day Observation |
| O | 1 | Sl. foam | Sl. foam | Sl. foam, Sl. syneresis |
| O | 2 | Sl. foam | Sl. foam | Sl. foam, Sl. syneresis |
| P | 1 | Sl. foam | Sl. foam | Sl. foam, Sl. syneresis |
| P | 2 | Sl. foam | Sl. foam | Sl. foam, Sl. syneresis |
| Q | 1 | Sl. foam | Sl. foam | Sl. foam, Sl. syneresis |
| Q | 2 | Sl. foam | Sl. foam | Sl. foam, Sl. syneresis |
| R | 1 | Sl. foam | Sl. foam | Sl. foam, Sl. syneresis |
| R | 2 | Sl. foam | Sl. foam | Sl. foam, Sl. syneresis |

### General Appearance of Painted Substrate

Paint samples with a hydrophobic evaporation suppressing material layer were shaken and applied to southern yellow pine board by painting with a paintbrush and allowed to cure for 24 hours at room temperature. Samples were visually assessed for brush marks, sagging, pinholes, bubbles, craters, seeding, opacity, or any other property that would be notable as detrimental to the quality of the paint film. No such defects were found for boards painted with any of Samples O, P, Q, or R.

### Dry Adhesion

Samples O, P, Q, and R were applied by brush to southern yellow pine board and by 5 mil Bird applicator drawdown to aluminum Q-panel.⁷ Dry adhesion was assessed according to ASTM D3359-17, test method B, after 1 day and 7 days cure time at room temperature and humidity. The results are shown in Table 9, with the percent area remaining reported.

TABLE 9
Percent Area Remaining on Substrate Following
ASTM D3359-17 Dry Adhesion Test.

| | Southern Yellow Pine | | Aluminum Q-Panel | |
|---|---|---|---|---|
| Sample | 1 Day | 7 Day | 1 Day | 7 Day |
| O | 100 | 100 | 8 | 100 |
| P | 100 | 100 | 0 | 100 |
| Q | 100 | 100 | 0 | 100 |
| R | 100 | 100 | 0 | 100 |

The results indicate nearly identical performance between all samples. ⁷ Available from Q-Lab Corporation, Westlake, Ohio.

### Recoatability

An evaluation of the ability of Samples O, P, Q, and R to be applied and adhere to a surface having on it (1) cured coatings from Samples O, P, Q, and R and (2) a pre-primer. To assess recoatability on itself (which would occur if multiple coats of paint were applied), Samples O, P, Q, and R were applied by brush to southern white pine board and allowed to cure for 7 days. The same samples were reshaken and applied again by brush to the same board and cured for an additional 7 days. To assess coatability on a primed surface, Samples O, P, Q, and R were applied by brush to southern white pine board that had been primed with Multi-Purpose Latex Primer, Product #B51W00450, available from The Sherwin-Williams Company, Cleveland, Ohio. All boards were then assessed for general coating appearance and dry adhesion. Dry adhesion was assessed according to ASTM D3359-17, test method B, after 1 day and 7 days cure time at room temperature and humidity. The results are shown in Table 9, with the percent area remaining reported. The results demonstrate identical performance of the samples.

TABLE 9
Appearance and Dry Adhesion Evaluation of Recoatability
on Itself and on Pre-primed Surface.

| | Recoated on itself | | Coated on Primer | |
|---|---|---|---|---|
| | Gen | Dry | Gen | Dry |
| Sample | Appearance | Adhesion | Appearance | Adhesion |
| O | No defects | 100 | No defects | 100 |
| P | No defects | 100 | No defects | 100 |
| Q | No defects | 100 | No defects | 100 |
| R | No defects | 100 | No defects | 100 |

### Gloss, Sheen

An evaluation of the specular gloss and sheen of the samples was evaluated. A 4 mil drawdown of each sample was prepared on leneta plain white cardstock. 20°, 60°, and 85° measurements were taken on a Byk Garner Haze/Gloss meter. Tests were performed per ASTM D523-14. Results (the relative luminance reflectance factor relative to polished glass) are shown in Table 10. The results showed nearly identical specular gloss and sheen across all samples.

TABLE 10
Specular Gloss and Sheen Results.

| Sample | 20° | 60° | 85° |
|---|---|---|---|
| O | 1.1 | 8.4 | 14.5 |
| P | 1.1 | 8.1 | 15 |
| Q | 1.2 | 8.7 | 15 |
| R | 1.2 | 8.8 | 15.2 |

What is claimed is:

1-38. (canceled)

39. A system for reducing in-can skinning of a coating composition in a container comprising:
an aqueous coating composition that includes at least a binder and optionally a pigment; and
optionally disposed on top of the aqueous coating composition, a float layer; and
disposed on top of the aqueous coating composition or if present, the float layer, a hydrophobic evaporation suppressing layer;
wherein the hydrophobic evaporation suppressing layer comprises:
one or more polyisobutylene polymers in an amount of about 20 to about 95 weight percent based on the weight of the evaporation suppressing layer;
one or more silicone polymers in an amount of about 0 to about 20 weight percent based on the weight of the evaporation suppressing layer;
one or more carriers in an amount of about 0 to about 20 weight percent based on the weight of the evaporation suppressing layer;
one or more surfactants in an amount of about 0 to about 10 based on the weight of the evaporation suppressing layer; and
one or more stabilizers present in an amount of 0 to 5 weight percent based on the weight of the evaporation suppressing layer.

40. The system of claim 39,
wherein the evaporation suppressing layer is a monolayer.

41. The system of claim 39,
wherein the float layer comprises water.

42. The system of claim 39,
wherein the float layer comprises a polyethylene glycol.

43. The system of claim 39,
wherein the float layer includes a humectant.

44. The system of claim 39,
wherein the float layer is present in an amount of at least 1 mL/gallon volume of container to at most about 500 mL/gallon volume of container.

45. The system of claim 39,
wherein the silicone polymer is present in an amount of at least 1 weight percent based on the weight of the composition of the evaporation suppressing layer.

46. The system of claim 39,
wherein the silicone polymer is a polydimethyl siloxane.

47. The system of claims 39,
wherein the carrier is present in an amount of at least 1 weight percent based on the weight of the composition of the evaporation suppressing layer.

48. The system of claim 39,
wherein the surfactant is present in an amount of at least 0.5 weight percent based on the weight of the composition of the evaporation suppressing layer.

49. The system of claim 39,
wherein the stabilizer is present in an amount of at least 0.5 weight percent based on the weight of the composition of the evaporation suppressing layer.

50. The system of claim 49,
wherein the stabilizer is acetic acid.

51. The system of claim 39,
wherein the container is a five gallon pail, and the evaporation suppressing layer is present in an amount of at least 0.05 mL per five gallon pail.

52. The system of claim 50, wherein the evaporation suppressing layer is present in an amount of at most 4.0 mL per five gallon pail container.

53. The system of claim 39, wherein the container including the coating composition has a headspace and the evaporation suppressing layer is present in an amount of at most 2.9 mL per 500 cm² of surface area of the headspace.

54. The system of claim 39, wherein the container including the coating composition has a headspace and the evaporation suppressing layer is present in an amount of at least 0.1 mL per 500 cm² headspace surface area.

55. The system of claim 39, wherein the coating composition further includes and additive and the additive comprises at least one of a pigment, a colorant, a dispersant, a preservative, an UV stabilizer, a wetting agent, an extender, a rheology modifier, or a coalescent.

56. The system of claim 39, wherein the evaporation suppressing layer or monolayer further comprises water.

57. The system of claim 39, wherein the PVC of the aqueous coating composition is between about 25 and about 75.

58. The system of claim 39, wherein the binder comprises at least one of a (meth) acrylic latex, a vinyl acrylic latex, or a styrene acrylic latex.

59. The system of claim 39, wherein the polymeric binder comprises a polyurethane.
